(19) United States
(12) Patent Application Publication
(10) Pub. No.: US 2009/0168294 A1
(43) Pub. Date: Jul. 2, 2009

(54) CAPACITOR

(76) Inventor: Chan Ho Park, Goyang-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/269,115

(22) Filed: Nov. 12, 2008

(30) Foreign Application Priority Data
Dec. 26, 2007 (KR) 10-2007-0137902

(51) Int. Cl. H01G 4/30

(52) U.S. Cl. 361/301.4

(57) ABSTRACT

A capacitor according to an embodiment can include a first dielectric layer; a first metal layer disposed below the first dielectric layer; a second dielectric layer disposed below the first metal layer; a second metal layer disposed below the second dielectric layer; a third dielectric layer disposed below the second metal layer; and a third metal layer disposed below the third dielectric layer and electrically connected to the first metal layer.

### CROSS-REFERENCE TO RELATED APPLICATION

The present application claims the benefit under 35 U.S.C. § 119 of Korean Patent Application No. 10-2007-0137902, filed Dec. 26, 2007, which is hereby incorporated by reference in its entirety.

### BACKGROUND

A merged memory logic (MML) is a device where a memory cell array part, such as a dynamic random access memory (DRAM), and an analog or peripheral circuit are integrated in one chip.

The multimedia functions of such a chip are greatly improved by means of the merged memory and logic semiconductor device so that high integration and high speed of the semiconductor device can be more efficiently accomplished compared to the prior art.

Of continuing interest is the implementation of a capacitor with a high capacity for the analog circuits of the MML utilized in high speed operations. A capacitor having a conventional polysilicon-insulator-polysilicon (PIP) structure uses a top electrode and a bottom electrode formed of conductive polysilicon. However, a native oxide film forms by an oxidation reaction between the top electrode/bottom electrode and an interface of a dielectric thin film, which causes the entire capacitance to lower. In addition, the capacitance of the PIP capacitor may be lowered by a depletion region formed on the polysilicon layer. Because of the lowered capacitance, the PIP capacitor is often not suitable for high speed and high frequency operations.

In order to address the disadvantages of the PIP capacitor in high speed and high frequency operations, the capacitor having the PIP structure has been replaced with a capacitor having a metal-insulator-metal (MIM) structure where metal is used for the top electrode and the bottom electrode. The capacitor having the MIM structure has small resistivity and no parasitic capacitance from depletion therein. Accordingly, the MIM capacitor is often used in a high performance semiconductor device.

As a further modification, a metal-oxide-metal (MOM) capacitor has been recently proposed.

The MOM capacitor is formed using a metal chemical mechanical polishing (CMP) process to planarize the layers. However, a dishing problem is generated during the metal CMP process, causing a problem of uniformity in the metal thickness. In addition, the oxide film used as the dielectric film of the MOM capacitor is also planarized using a CMP process, and also is susceptible to the dishing problem, which leads to further non-uniformity in metal thickness.

As described above, when the thickness of the metal or the dielectric film is not uniform, the capacitor cannot obtain uniform capacitance. In addition, the non-uniformity of the thickness also has a bad influence on linearity and matching characteristics of the capacitor.

### BRIEF SUMMARY

Embodiments of the present invention relate to a capacitor.

According to an embodiment, a capacitor formed of a metal layer and a dielectric layer having a uniform thickness is provided by inhibiting a generation of dishing phenomenon.

In an embodiment, a capacitor is provided having parallel, vertically connected metal layers.

A capacitor according to an embodiment includes: a first dielectric layer; a first metal layer disposed below the first dielectric layer; a second dielectric layer disposed below the first metal layer; a second metal layer disposed below the second dielectric layer; a third dielectric layer disposed below the second metal layer; and a third metal layer disposed below the third dielectric layer and electrically connected to the first metal layer.

### BRIEF DESCRIPTION OF THE DRAWINGS

FIG. 1 is a plan view of a capacitor according to an embodiment of the present invention.

FIG. 2 is a plan view of a first metal layer of the capacitor of FIG. 1 according to an embodiment of the present invention.

FIG. 3 is a plan view of a second metal layer of the capacitor of FIG. 1 according to an embodiment of the present invention.

FIG. 4 is a cross-sectional view taken along line A-A′ of the capacitor shown in FIG. 1 according to an embodiment of the present invention.

FIG. 5 is a cross-sectional view taken along line B-B′ of the capacitor shown in FIG. 1 according to an embodiment of the present invention.

### DETAILED DESCRIPTION

Hereinafter, a capacitor according to an embodiment of the present invention will be described in detail with reference to the accompanying drawings.

According to embodiments of the present invention, a vertical parallel plate capacitor is provided.

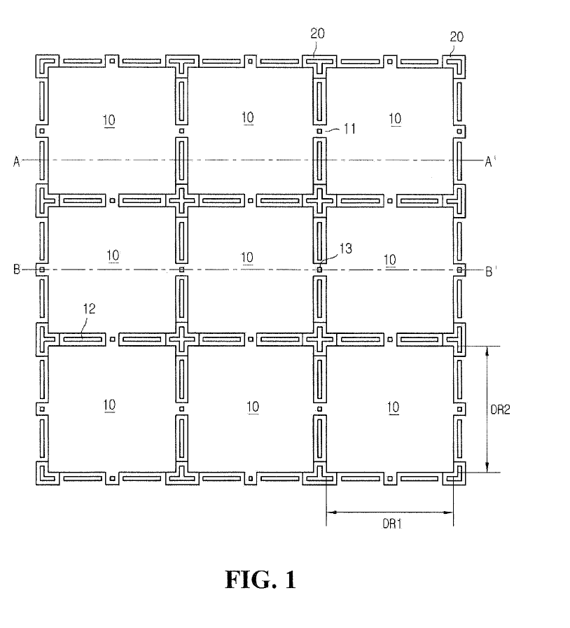

FIGS. 1 to 5 are views for explaining a capacitor according to the embodiment.

Referring to FIGS. 1 to 5, a plurality of metal layers can be vertically arranged having a dielectric layer 50 therebetween. According to an embodiment, the capacitor can include a first dielectric layer 51, a first metal layer 10, a second dielectric layer 52, a second metal layer 20, a third dielectric layer 53, a third metal layer 30, a fourth dielectric layer 54, a fourth metal layer 40, and a fifth dielectric layer 55 disposed in a vertical arrangement.

A first voltage can be applied to the first metal layer 10 and the third metal layer 30, and a second voltage can be applied to the second metal layer 20 and the fourth metal layer 40. Therefore, a plurality of vertical capacitors can be provided. In an embodiment, the first voltage can be a high voltage and the second voltage can be a low voltage.

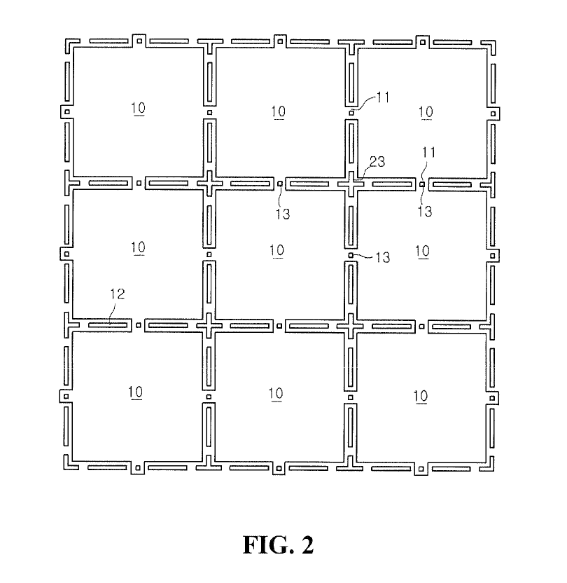

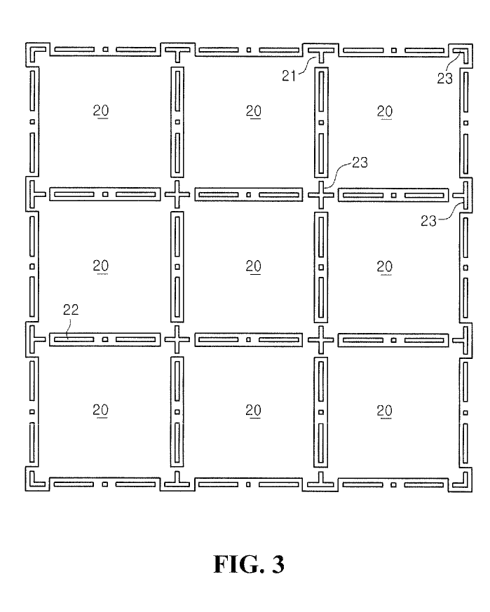

Although the layout for only the first metal layer 10 and the second metal layer 20 are shown in FIGS. 2 and 3, the third metal layer 30 can be formed having the same arrangement as the first metal layer 10, and the fourth metal layer 40 can be formed having the same arrangement as the second metal layer 20.

In order to assist an understanding of an embodiment, it should be noted that FIG. 1 provides an illustration of where the first metal layer 10 is disposed overlapping the second metal layer 20 (e.g., FIG. 2 overlapped with FIG. 3).

Referring to FIG. 1, a unit metal layer can be provided having a width DR1 and a length DR2. The unit metal layer can be provided in plurality. For example, nine unit metal layers for each metal layer are illustrated in FIG. 1.

In FIGS. 1-3, nine first metal unit metal layers 10 arranged as a 3×3 matrix are disposed on the same horizontal surface. Likewise, below the nine first metal unit metal layers 10, nine second metal unit metal layers 20 arranged as a 3×3 matrix are disposed on the same horizontal surface.

Referring to FIG. 2, the plurality of first metal unit metal layers 10 can be connected to each other through first bridges 11. The first bridges 11 can be disposed connecting sides of the first metal unit metal layers 10. And, dummy first metal layers 12 can be provided in regions between the adjacent ones of the plurality of first metal unit metal layers 10.

In addition, referring to FIG. 3, the plurality of second metal unit metal layers 20 can be connected to each other through second bridges 21. In an embodiment, the second bridges 21 can be arranged connecting corners of the second metal unit metal layers 20. And, dummy second metal layers 22 can be provided in regions between adjacent ones of the plurality of second metal unit metal layers 20.

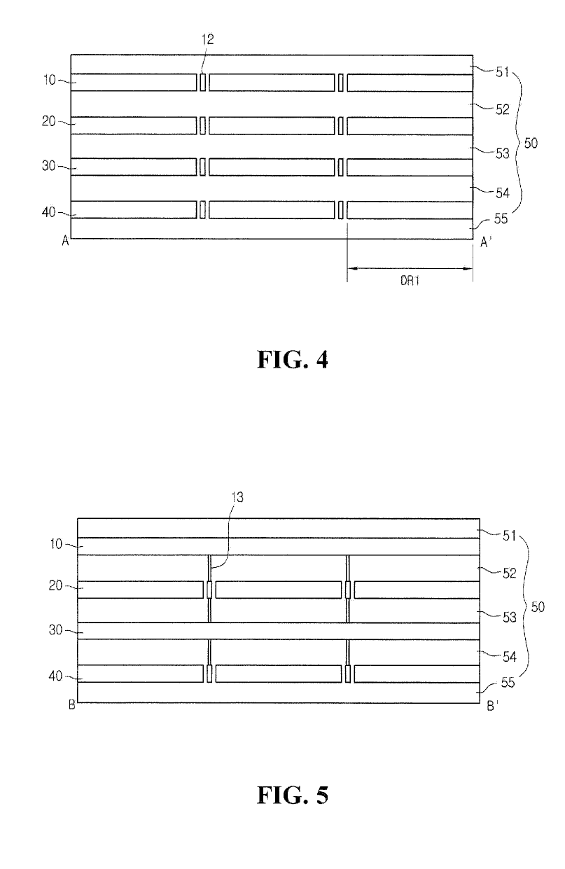

As shown in the Figures, the dummy metal layers 12 and 22 can be disposed between the unit metal layers. According to certain embodiments, as shown in FIG. 4, the dummy metal layers (12 and 22) can be vertically aligned for each of the metal layers (10, 20, 30, and 40).

When the first and second metal layers 10 and 20 are formed of aluminum, the dummy metal layers can inhibit a micro-loading effect generated from edges of the first and second metal layers 10 and 20, and when the first and second metal layers 10 and 20 are formed of copper, the dummy metal layers can inhibit a dishing phenomenon of the dielectric layer during a copper (Cu) damascene process.

In particular, when the first and second metal layers 10 and 20 are made of copper, the area of the unit metal layer can be formed as a maximum area that can inhibit a metal dishing phenomenon during the copper damascene process, or an area below the maximum area.

As shown in FIGS. 1 and 5, the first metal layer 10 and the third metal layer 30 can be electrically connected through a via 13. A plurality of vias 13 can be formed to supply sufficient current to each unit metal layer.

Also, as shown in FIG. 3, the second metal layer 20 and the fourth metal layer 40 can be electrically connected through a via 23. A plurality of vias 23 can be formed to supply sufficient current to each unit metal layer.

Referring to FIG. 1, the via 23 connecting the second metal layer 20 and the fourth metal layer 40 can be isolated electrically from the first metal unit metal layers 10 and third metal unit metal layers 30, and as shown in FIG. 3, the via 13 connecting the first metal layer 10 and the third metal layer 30 can be isolated electrically from the second metal layer 20 and fourth metal layer 40.

According to an embodiment, the dielectric layer 50 can include a first dielectric layer 51, a second dielectric layer 52, a third dielectric layer 53, a fourth dielectric layer 54 and a fifth dielectric layer 55. The dielectric layer 50 can be made of an oxide based material such as an oxide film.

The capacitor described above forms respective metal layers as a plurality of unit metal layers and connects the unit metal layers of using bridges, making it possible to inhibit the dishing phenomenon or micro-loading effect that may occur during the CMP process.

Also, the capacitor described above vertically disposes metal layers to which a first voltage (e.g., a high-voltage) and a second voltage (e.g., a low-voltage or a ground) are applied in alternation, making it possible to enhance the integration of the capacitor.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A capacitor comprising:
a first dielectric layer;
a first metal layer disposed below the first dielectric layer;
a second dielectric layer disposed below the first metal layer;
a second metal layer disposed below the second dielectric layer;
a third dielectric layer disposed below the second metal layer; and
a third metal layer disposed below the third dielectric layer, the third metal layer being electrically connected to the first metal layer.

2. The capacitor according to claim 1, wherein the first metal layer is electrically connected to the third metal layer through a via.

3. The capacitor according to claim 2, wherein the second metal layer is provided as a plurality of connected second metal unit metal layers, wherein the via electrically connecting the first metal layer to the third metal layer is electrically isolated from the second metal layer by passing through a region between adjacent second metal unit metal layers of the second metal layer.

4. The capacitor according to claim 3, wherein the plurality of connected second metal unit metal layers are electrically connected to each other through bridges.

5. The capacitor according to claim 4, wherein the bridges are disposed connecting corners of adjacent second metal unit metal layers.

6. The capacitor according to claim 1, further comprising:
a fourth dielectric layer disposed below the third metal layer; and
a fourth metal layer disposed below the fourth dielectric layer, the fourth metal layer being electrically connected to the second metal layer.

7. The capacitor according to claim 6, wherein the second metal layer is electrically connected to the fourth metal layer through a via.

8. The capacitor according to claim 7, wherein the third metal layer is provided as a plurality of connected third metal unit metal layers wherein the via electrically connecting the second metal layer to the fourth metal layer is electrically isolated from the third metal layer by passing through a region between adjacent third metal unit metal layers of the third metal layer.

9. The capacitor according to claim 6, wherein the first metal layer comprises a plurality of connected first metal unit metal layers arranged in a same horizontal plane,
wherein the second metal layer comprises a plurality of connected second metal unit metal layers arranged in a same horizontal plane,
wherein the third metal layer comprises a plurality of connected third metal unit metal layers arranged in a same third horizontal plane, and
wherein the fourth metal layer comprises a plurality of connected fourth metal unit metal layers arranged in a same horizontal plane.

10. The capacitor according to claim 9, wherein each of the plurality of first metal unit metal layers is vertically arranged with a corresponding one of the plurality of second metal unit metal layers, a corresponding one of the plurality of third metal unit metal layers, and a corresponding one of the plurality of fourth metal unit metal layers.

11. The capacitor according to claim 9, further comprising:
first dummy metal layers disposed between first metal unit metal layers of the plurality of first unit metal layers;
second dummy metal layers disposed between second metal unit metal layers of the plurality of second unit metal layers;
third dummy metal layers disposed between third metal unit metal layers of the plurality of third unit metal layers; and
fourth dummy metal layers disposed between fourth metal unit metal layers of the plurality of fourth unit metal layers.

12. The capacitor according to claim 9, wherein the plurality of connected first metal unit metal layers are electrically connected to each other through first bridges;
wherein the plurality of connected second metal unit metal layers are electrically connected to each other through second bridges,
wherein the plurality of connected third metal unit metal layers are electrically connected to each other through third bridges, and
wherein the plurality of connected fourth metal unit metal layers are electrically connected to each other through fourth bridges.

13. The capacitor according to claim 12, wherein the first bridges connect sides of adjacent ones of the plurality of first metal unit metal layers, wherein the second bridges connect corners of adjacent ones of the plurality of second metal unit metal layers, wherein the third bridges connect sides of adjacent ones of the plurality of third metal unit metal layers, and wherein the fourth bridges connect corners of adjacent ones of the plurality of fourth metal unit metal layers.

14. The capacitor according to claim 6, wherein the first dielectric layer, the second dielectric layer, the third dielectric layer, and the fourth dielectric layer are each made of an oxide film.
